(19) United States
(12) Patent Application Publication
(10) Pub. No.: US 2007/0079877 A1
(43) Pub. Date: Apr. 12, 2007

(54) Structure of crankcase pressure control valve with bent nipple

(76) Inventor: Yong-Kyoon Kim, Yongin-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/285,435

(22) Filed: Nov. 22, 2005

(30) Foreign Application Priority Data
Oct. 6, 2005 (KR) 10-2005-0093766

(51) Int. Cl. F16K 31/12

(52) U.S. Cl. 137/497

(57) ABSTRACT

A crankcase pressure control valve with a bent nipple with a machined hole sealed later by a plug formed on a valve body. The crankcase pressure control valve has the bent nipple which makes linear access to the interior of the valve body difficult, thus allowing a bypass hole to be formed in the valve body through a relatively easy method using a slide core metal mold.

### CROSS-REFERENCE TO RELATED APPLICATIONS

The present application is based on, and claims priority from, Korean Application Serial Number 10-2005-0093766, filed on Oct. 6, 2005, the disclosure of which is hereby incorporated by reference herein in its entirety.

### FIELD OF THE INVENTION

The present invention relates, in general, to the structure of a crankcase pressure control valve with a bent nipple and, more particularly, to the structure of a crankcase pressure control valve, which has difficulty in linearly accessing the interior of a valve body, due to a bent nipple that is integrated with the valve body into a single structure.

### BACKGROUND OF THE INVENTION

A crankcase pressure control valve (CCPCV) is installed between a breather hose and an intake hose, and serves to suppress the flow of blow-by gas which flows through the breather hose to the intake hose, when excessive intake negative pressure is generated.

Nipples, which are connected to the breather hose and the intake hose, respectively, are provided on a valve body of the CCPCV. A diaphragm is provided in the valve body and is supported by a spring to control blow-by gas which flows between the nipple connected to the breather hose and the nipple connected to the intake hose. A throttle boss is provided at a position around the nipple connected to the intake hose, and blocks the flow of blow-by gas in cooperation with the diaphragm.

When the intake negative pressure increases suddenly, the diaphragm deforms the spring and is pulled toward the nipple connected to the intake hose, thus closing a throttle hole of the throttle boss, therefore preventing pressure in a cylinder head cover and a crankcase from being suddenly lowered.

A bypass hole is formed on the throttle boss to bypass the throttle hole which may be completely opened or closed by the diaphragm. The bypass hole prevents the diaphragm from suddenly moving while resonating.

Meanwhile, the nipple connected to the breather hose is formed to be integrated with the valve body. In this case, the nipple may have a bent structure, in consideration of the arrangement in an engine room and other peripheral components. The bent structure makes it difficult to linearly access the interior of the valve body.

### SUMMARY OF THE INVENTION

Embodiments of the present invention provide a structure of a crankcase pressure control valve having a bent nipple which is formed in consideration of the arrangement in an engine room and other peripheral components but makes it difficult to linearly access the interior of a valve body, and allow a bypass hole to be easily formed in the valve body of the crankcase control valve having the bent nipple.

A structure of a crankcase pressure control valve with a bent nipple according to an embodiment of the present invention includes a valve body having a shape of a bowl which is open at an upper portion thereof. A cap closes an upper portion of the valve body. A diaphragm is mounted to a lower portion of the cap. An intake hose nipple protrudes downwards from a lower portion of the valve body, and is connected to an intake hose. A throttle boss protrudes upwards from an interior of the valve body to communicate with the intake hose nipple, with a protruding end of the throttle boss forming a throttle hole which is open toward a lower portion of the diaphragm. A bent nipple is shaped such that it extends slantingly upwards from a sidewall of the valve body, and is connected to a breather hose. A bypass hole is formed on a sidewall of the throttle boss. An access hole is formed on the sidewall of the valve body to allow linear access from an exterior of the valve body to the bypass hole. A plug closes the access hole.

### BRIEF DESCRIPTION OF THE DRAWINGS

For a better understanding of the nature and objects of the present invention, reference should be made to the following detailed description with the accompanying drawings, in which:

FIG. 1 illustrates the structure of a crankcase pressure control valve with a bent nipple, according to and embodiment of the present invention; and

FIG. 2 is a section view of the valve, shown from a direction different from that of FIG. 1.

### DETAILED DESCRIPTION OF THE PREFERRED EMBODIMENTS

Hereinafter, the preferred embodiment of the present invention will be described with reference to the accompanying drawings.

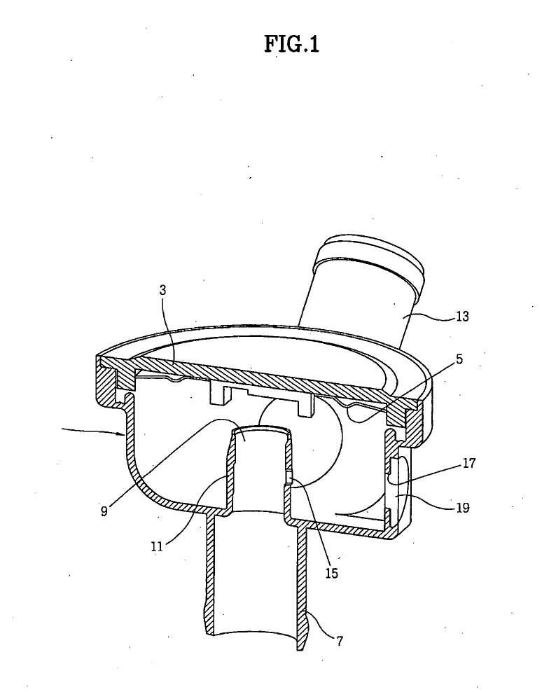

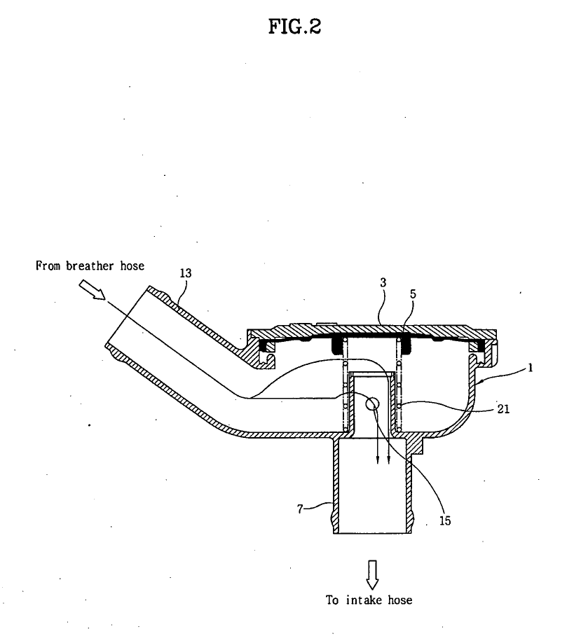

Referring to FIGS. 1 and 2, a crankcase pressure control valve, according to the present invention, includes a valve body 1 having the shape of a bowl which is open at an upper portion thereof. A cap 3 closes the upper portion of the valve body 1. A diaphragm 5 is installed on the lower portion of the cap 3. An intake hose nipple 7 is provided on the lower portion of the valve body 1 to protrude downwards from the valve body 1, and is connected to an intake hose. A throttle boss 11 protrudes upwards from the interior of the valve body 1, and communicates with the intake hose nipple 7. A protruding end of the throttle boss 11 forms a throttle hole 9 which is open toward the lower portion of the diaphragm 5. A bent nipple 13 is provided on the side surface of the valve body 1 in such a way as to extend upwards at an angle, and is connected to a breather hose. A bypass hole 15 is formed on the sidewall of the throttle boss 11. An access hole 17 is formed on the sidewall of the valve body 1 to allow an external tool to access the bypass hole 15 in a straight line. A plug 19 closes the machining hole 17.

Further, a coil spring 21 is provided between the diaphragm 5 and the valve body 1 such that the inner circumference of the coil spring 21 is in contact with the throttle boss 11. The coil spring 21 is omitted in FIG. 1.

The plug 19 is secured to the valve body 1 through welding.

In the CCPCV constructed as described above, the bent nipple 13 is connected to the breather hose extending from a cylinder head cover of an engine, and the intake hose nipple 7 is connected to the intake hose. Thereby, the PCV controls the flow of blow-by gas which flows from the interior of the cylinder head cover through the intake hose to a combustion chamber, due to negative pressure which is generated in the intake hose.

In the CCPCV, the valve body I is formed together with the intake hose nipple 7 and the bent nipple 13. The bypass hole 15 of the throttle boss 11 is formed by a slide core which is installed through the hole 17. Since the bypass hole 15 is very small, it is difficult to form the bypass hole 15 through methods other than a method using a slide core. However, the hole 17 is used to form the bypass hole 15 using the slide core. In this way, after the valve body 1 has been formed, the plug 19 is fitted into the hole 17 and then is welded, thus closing the hole 17.

The cap 3 is separately manufactured. After the coil spring 21 and the diaphragm 5 are installed in the valve body 1, the cap 3 is coupled to the valve body 1 to close the upper portion of the valve body 1.

As apparent from the foregoing, an access hole sealed later by a plug is formed on a valve body of a crankcase pressure control valve having a bent nipple which makes linear access to the interior of the valve body difficult, thus allowing a bypass hole to be precisely formed in the valve body through a relatively easy method using a slide core metal mold.

What is claimed is:

1. A crankcase pressure control valve structure having a bent nipple, comprising:
a valve body having a shape of a bowl which is open at an upper portion thereof;
a cap to close an upper portion of the valve body;
a diaphragm mounted to a lower portion of the cap;
an intake hose nipple protruding downward from a lower portion of the valve body, for connection to an intake hose;
a throttle boss protruding upwards from an interior of the valve body to communicate with the intake hose nipple, said boss having a protruding end forming a throttle hole open toward a lower portion of the diaphragm;
a bent nipple configured and dimensioned to extend slantingly upwards from a sidewall of the valve body for connection, to a breather hose;
a bypass hole formed on a sidewall of the throttle boss;
a hole formed on the sidewall of the valve body to allow linear access from an exterior of the valve body to the bypass hole; and
a plug closing said hole.

2. The crankcase pressure control valve structure as defined in claim 1, wherein a coil spring is provided between the diaphragm and the valve body, with an inner circumference of the coil spring being fitted over the throttle boss.

3. The crankcase pressure control valve structure as defined in claim 2, wherein the plug is secured to the valve body through welding.
